(19) United States
(12) Patent Application Publication
(10) Pub. No.: US 2015/0055283 A1
(43) Pub. Date: Feb. 26, 2015

(54) ELECTRICAL DEVICE

(71) Applicants: Inventec Corporation, Taipei (TW); Inventec (Pudong) Technology Corporation, Shanghai (CN)

(72) Inventors: Jin ZHANG, Shanghai (CN); JianXin ZHOU, Shanghai (CN)

(73) Assignees: Inventec Corporation, Taipei (TW); Inventec (Pudong) Technology Corporation, Shanghai (CN)

(21) Appl. No.: 14/078,173

(22) Filed: Nov. 12, 2013

(30) Foreign Application Priority Data
Aug. 22, 2013 (CN) 201310371330.7

(51) Int. Cl. G06F 1/16; G06F 1/20

(52) U.S. Cl. CPC G06F 1/1656; G06F 1/203
USPC 361/679.5; 361/679.55

(57) ABSTRACT

An electrical device includes a housing, a motherboard module and a holding assembly. The housing includes a top shell and a bottom shell which are assembled with each other. The top shell has a top wall and a hook fixed to the top wall. The bottom shell has a bottom wall which is opposite to the top wall. The hook is located on an area of the top wall which faces toward the bottom wall. The motherboard module is located on the bottom wall. The motherboard module includes a motherboard and a central processing unit located on the motherboard. The holding assembly is securely located on the motherboard module and hung on the hook for providing an upward pulling force for the motherboard module.

### CROSS-REFERENCE TO RELATED APPLICATIONS

This non-provisional application claims priority under 35 U.S.C. §119(a) on Patent Application No(s). 201310371330.7 filed in China on Aug. 22, 2013, the entire contents of which are hereby incorporated by reference.

### TECHNICAL FIELD

The disclosure relates to an electrical device, more particularly to an electrical device having a holding assembly and a hook.

### BACKGROUND

The functions of the electrical device have increasingly advanced with the development of technology. Besides, consumers look forward to adjusting the units of the electrical device and their functions according to individual's demand. Taking a server rack for an example, the server rack comprises a cabinet and a plurality of servers. A plurality of tracks paralleled to each other are located inside the cabinet, and the servers are stacked up and detachably located on the tracks. Therefore, the servers are located on or removed from the cabinet according to consumers' demands, which adjusts the operation and the storage of each server rack.

In general, a server comprises a housing and a plurality of motherboard modules. The housing includes a top shell and a bottom shell, and the motherboard modules are located between the top shell and the bottom shell and are loaded on the bottom wall of the bottom shell. The plurality of servers are sequentially located inside the cabinet and are assembled along tracks which are parallel to each other, respectively, or the servers are removed from the cabinet along the tracks. However, the top shell outward protrudes due to the manufacturing tolerance, which leads to the interference for the other server located above top shell. Moreover, the motherboard module loaded on the bottom shell leads to the deformation and sink of the bottom wall of the bottom shell, which may interfere with their server located below the bottom shell.

### SUMMARY

An embodiment of the disclosure provides an electrical device comprising a housing, a motherboard module and a holding assembly. The housing includes a top shell and a bottom shell which are assembled with each other. The top shell has a top wall and a hook fixed to the top wall. The bottom shell has a bottom wall which is opposite to the top wall. The hook is located on an area of the top wall which faces toward the bottom wall. The motherboard module is located on the bottom wall. The motherboard module includes a motherboard and a central processing unit located on the motherboard. The holding assembly is securely located on the motherboard module and hung on the hook for providing an upward pulling force for the motherboard module.

According to the electrical device of the disclosure, the holding assembly securely located on the motherboard module is hung on the hook, and the hook provides the upward pulling force for motherboard module, which reduces the pressure of the motherboard module applying to the bottom wall and further restrains the deformation of the bottom wall.

### BRIEF DESCRIPTION OF THE DRAWING

The disclosure will become more fully understood from the detailed description given herein below and the drawing are for illustration only, and thus does not limit the present disclosure, wherein:

FIG. 1 is a perspective view of an electrical device according to an embodiment of the disclosure;

FIG. 2 is an exploded view of the electrical device at a first angle according to an embodiment of the disclosure;

FIG. 3A is an enlarged and exploded view of the electrical device at the first angle according to an embodiment of the disclosure;

FIG. 3B is an enlarged and exploded view of the electrical device at a second angle according to an embodiment of the disclosure;

FIG. 4 is a partially sectional view of the electrical device according to an embodiment of the disclosure; and

FIG. 5 is a partially sectional view of the electrical device according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An embodiment of the disclosure provides an electrical device for storing or operating data. In this embodiment, the electrical device is a server, but the disclosure is not limited thereto. In addition, the multiple electrical devices are located inside a server rack (or cabinet) and the adjacent electrical devices are separated by a distance which is larger than zero.

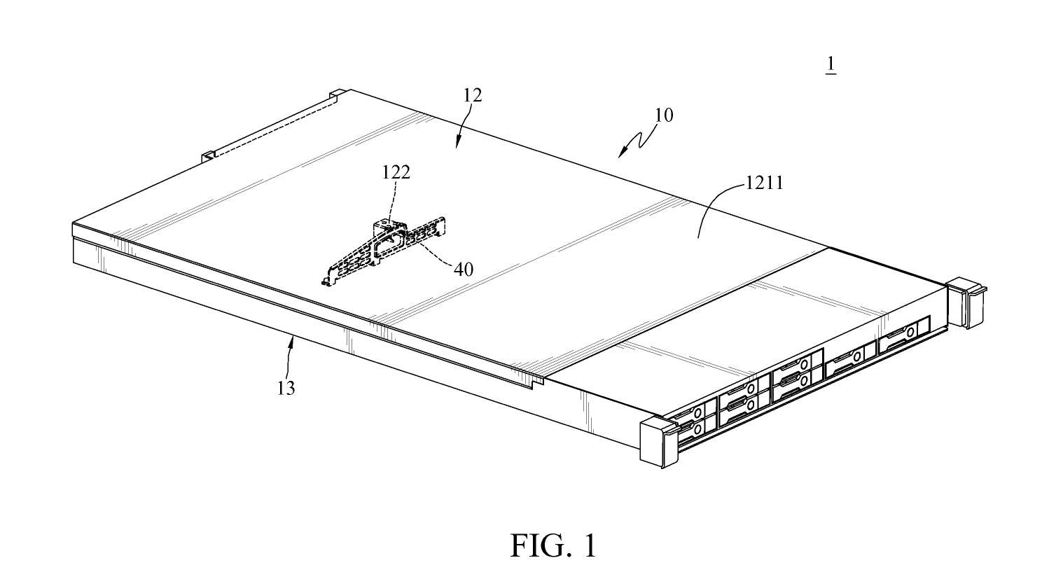

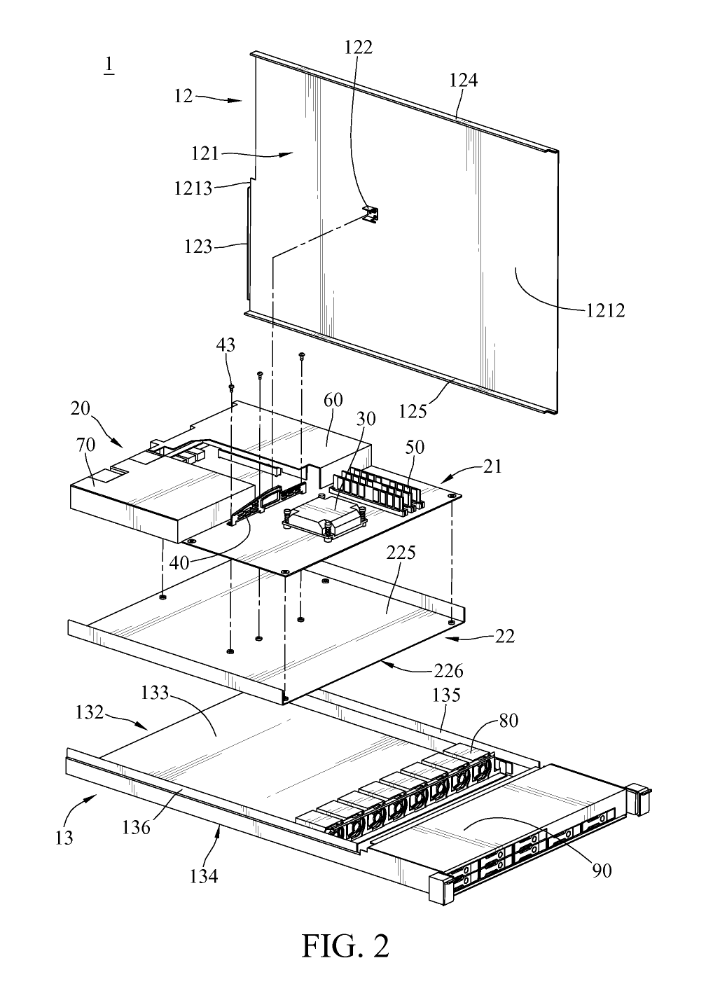

Please refer to FIG. 1 and FIG. 2. FIG. 1 is a perspective view of an electrical device according to an embodiment of the disclosure. FIG. 2 is an exploded view of the electrical device at a first angle according to an embodiment of the disclosure. An embodiment of the disclosure provides an electrical device 1 comprising a housing 10, a motherboard module 20 and a holding assembly 40. The holding assembly 40 is securely located on the motherboard module 20, and the holding assembly 40 and the motherboard module 20 are located inside the housing 10.

The housing 10 includes a top shell 12 and a bottom shell 13 which are assembled with each other. The top shell 12 has a top wall 121 and a hook 122 fixed to top wall 121. The top wall 121 has a first surface 1211 and a second surface 1212, and the first surface 1211 and the second surface 1212 are opposite to each other. In this and some other embodiments of the disclosure, the top shell 12 further comprises two edgefolds 124, 125 and a strengthen strip 123. The two edgefolds 124,125 are located on two opposite sides of the top wall 121 respectively. The strengthen strip 123 is extended from a side edge 1213 of the top wall 121 and located between the two edgefolds 124,125 of the top shell 12 and is formed by bending from the side edge 1213 of the top wall 121 to face toward the bottom shell 13. The strengthen strip 123 is used for strengthening the top wall 121′s ability against deformation. The strengthen strip 123 is adapted for preventing the top wall 121 from being curved when a force is applied to the top wall 121, such that the first surface 1211 and the second surface 1212 be able to keep level.

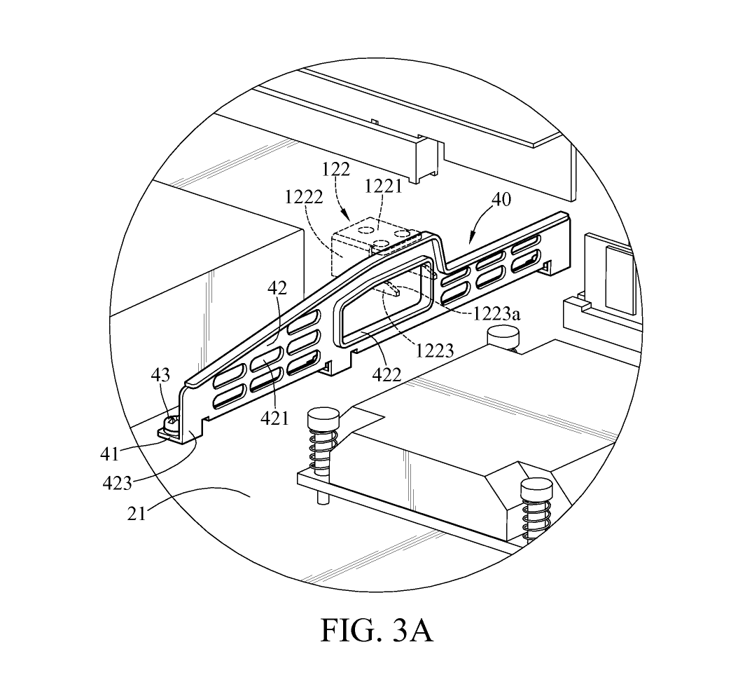

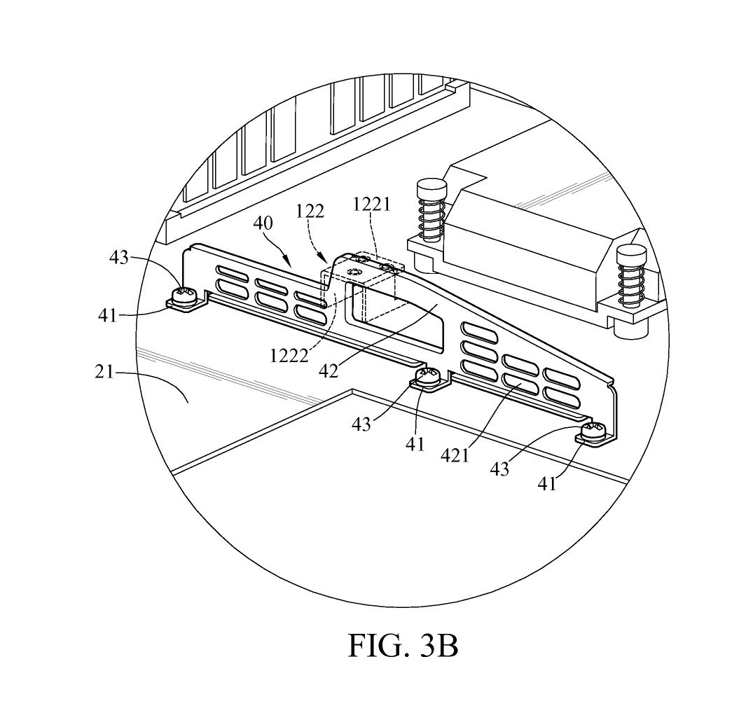

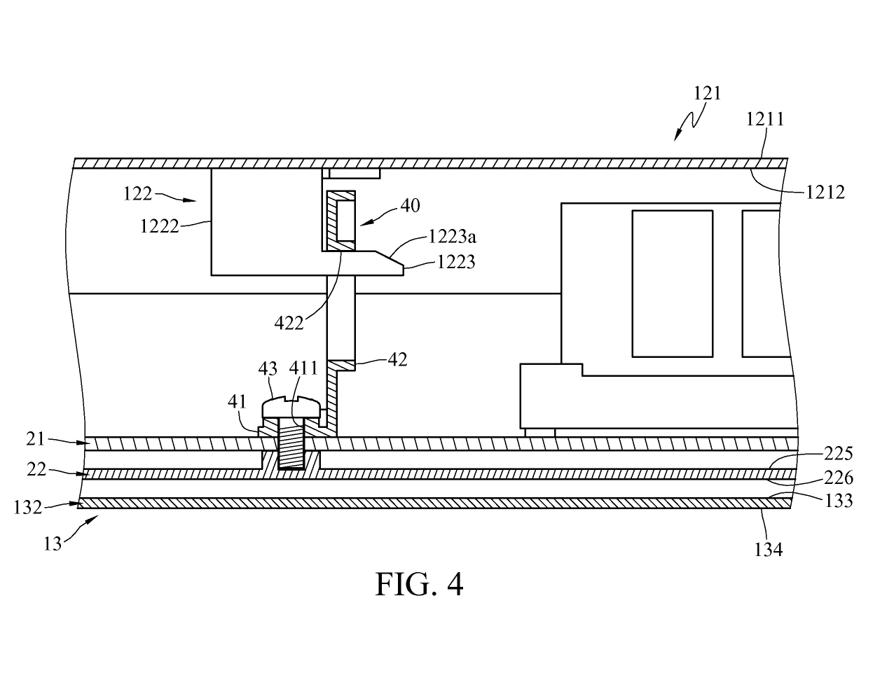

Please refer to FIG. 3A, FIG. 3B and FIG. 4. FIG. 3A is an enlarged and exploded view of the electrical device at the first angle according to an embodiment of the disclosure. FIG. 3B is an enlarged and exploded view of the electrical device at a second angle according to an embodiment of the disclosure. FIG. 4 is a partially sectional view of the electrical device according to an embodiment of the disclosure. The hook 122 is located on an area of the top wall 121 which faces toward the bottom wall 132, namely, the hook 122 is securely located on the second surface 1212 of the top wall 121. In this and some other embodiments of the disclosure, the hook 122 includes a connecting section 1221, an extended section 1222 and a hook section 1223. The connecting section 1221 is riveted on the top shell 12, the extended section 1222 extends toward the bottom wall 132 from the connecting section 1222, and the hook section 1223 extends from the extended section 1222. In this and some other embodiments of the disclosure, a guiding surface 1223a which is inclined is formed from a free end of the hook section 1223. The top shell 12 is assembled to the bottom shell 13 along a front to back direction; the hook section 1223 extends from the extended section 1222 along the front to back direction; with the top shell 12 assembled to the bottom shell 13 along the front to back direction, the holding assembly 40 is hung on the hook section 1223 along a back to front direction. In one embodiment, the hook section 1223 is parallel to the motherboard 21.

Please refer to FIG. 2 and FIG. 4. In this embodiment of the disclosure, the bottom shell 13 has a bottom wall 132 which is opposite to the top wall 121. Specifically, the bottom wall 132 includes a third surface 133 and a fourth surface 134 which is opposite to the third surface 133, and the third surface 133 faces toward the hook 122. In this and some other embodiments of the disclosure, the bottom shell 13 further comprises two side walls 135, 136 which are located on two opposite sides of the bottom wall 132 respectively, the two side walls 135, 136 extend from the bottom wall 132 toward the top wall 121 and are formed by bending from the two opposite sides of the bottom wall 132 respectively. The top shell 12 is assembled on top sides of the two side walls 135, 136 of the bottom shell 13 and the two edgefolds 124, 125 directly abut against the two side walls 135, 136, respectively. Therefore, the two edgefolds 124, 125 and the two side walls 135, 136 which cooperate with each other improve the secure installation of the top shell 12 and the bottom shell 13.

Please continually refer to FIG. 2 and FIG. 4. The motherboard module 20 is located on the bottom wall 132. The motherboard module 20 comprises a motherboard 21, a central processing unit_(CPU) 30 and a tray 22. The CPU 30 is located on the motherboard 21 and is used for processing the operation of the electrical device 1. The tray 22 is used for loading the motherboard 21 which is located between the top wall 121 and the tray 13. Specifically, the motherboard 21 is securely locked on the tray 22, and the motherboard 21 and the tray 22 are integrally mounted to the bottom wall 132 of the bottom shell 13. The motherboard module 20 is loaded on the bottom wall 132 and generates pressure toward the bottom wall 132 due to its weight, which may result in the deformation of the bottom wall 132. However, the above-mentioned statement is the problem that this disclosure tries to solve. The motherboard module 20 and the bottom wall 132 are securely connected by fixing assembly, for example, a convex pillar (not shown) is located on the bottom wall 132 and a keyhole (not shown) is located on the tray 22, the convex pillar is engaged with the keyhole. Furthermore, in this and some other embodiments of the disclosure, the tray 22 has a fifth surface 225 and a sixth surface 226 which is opposite to the fifth surface 225. The motherboard 21 is loaded on the fifth surface 225 of the tray 22 and the sixth surface 226 faces toward the bottom wall 132.

In this embodiment of the disclosure and some part of the disclosure, the electrical device 1 further comprises a plurality of fans 80 and a plurality of hard disk drives 90, and both of the plurality of fans 80 and the plurality of hard disk drives 90 are located on the third surface 133 of the bottom shell 13. The plurality of fans 80 are used for dissipating thermal energy generated from the motherboard module 20 and the plurality of hard disk drives 90 are used for storing data. In addition, the motherboard module 20 further comprises a slot connector 50, an expansion module 60 and a power supply unit 70, which are all located on the motherboard 21. The slot connector 50 is located next to the CPU 30 and is used for being electrically connected to a module. For example, a memory module (not shown) is electrically connected with the slot connector 50. The expansion module 60 is located on one side of the motherboard 21 and is next to the strengthen strip 123 as well, and is operable in specific function. The power supply unit 70 is located next to the expansion module 60 and is used for receiving and converting the external electrical energy, such that the power supply unit 70 provides the electrical energy for other components inside the electrical device 1.

Please refer to FIG. 2, FIG. 3A, FIG. 3B and FIG. 4. The holding assembly 40 is securely located on the motherboard module 20 and is hung on the hook section 1223 of the hook 122 for providing an upward pulling force for the motherboard module 20. In this and some other embodiments of the disclosure, the holding assembly 40 is located among the CPU 30, the expansion module 60 and the power supply unit 70. The holding assembly 40 includes a fixing portion 41, a hanging portion 42 and a fastener 43. The fixing portion 41 extends from a bottom side 423 of the hanging portion 42 by bending from the bottom side 423 of the hanging portion 42, and the fixing portion 41 is fastened to the motherboard 21. The fixing portion 41 further includes a perforation 411 and the hanging portion 42 is hung on the hook 122. Specifically, the hanging portion 42 has a through opening 422. The guiding surface 1223a of the hook 122 guides the holding assembly 40 to be hung on the hook section 1223, and the hook section 1223 of the hook 122 passes through the through opening 422 and is contacted and engaged with the inner surface of the through opening 422. Furthermore, the hanging portion 42 faces toward the plurality of fans 80 and has a plurality of vents 421, the through opening 422 is one vent of plurality of vents 421, the airflow generated from the operation of the plurality of fans 80 partially passes through the plurality of vents 421. Therefore, the holding assembly 40 with the plurality of vents 421 is beneficial for the heat dissipation inside the electrical device 1. Besides, the fastener 43 passes through the perforation 411 of the fixing portion 41 and the motherboard 21 to fasten with the tray 22. In other words, the hook 122 pulls the holding assembly 40 to enable top shell 12 share the weight of the motherboard 21 and the tray 22 with the bottom shell 13. Therefore, it prevents the top shell 12 and the bottom shell 13 from being protruded from the electrical device 1 toward outside (namely, from being curved).

In addition, in this and some other embodiments of the disclosure, the fastener 43 is a screw and the tray 22 has a nut 221, and the screw is screwed to the nut 221. However, the fixation manner by the screw and the nut 221 is not limited to the disclosure. In some embodiment of the disclosure, the holding assembly 40 is located on the motherboard 21 by the engagement, and in other embodiment of the disclosure, the holding assembly 40 is located on the motherboard 21 by rivet.

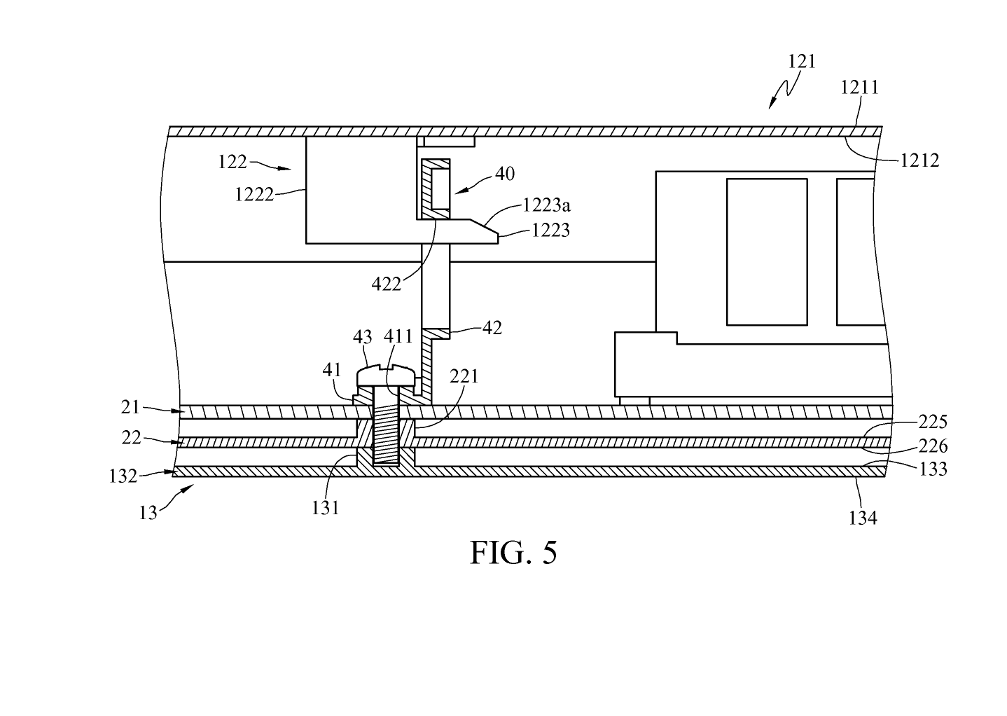

The fixation manner of the motherboard 21 and the tray 22 is not limited to the disclosure. Please refer to FIG. 5, which is a partially sectional view of the electrical device according another embodiment of the disclosure. In this embodiment of the disclosure, the bottom shell 13 has a nut 131. The fastener 43 sequentially passes through the perforation 411 of the fixing portion 41, the fifth surface 225 and the sixth surface 226 of the tray 22, which enables the fastener 43 to be screwed to the nut 131 of the bottom shell 13. Therefore, the motherboard 21, the tray 22 and the bottom shell 13 can be regarded as a whole. When the holding assembly 40 is hung on the hook 212, the holding assembly 40 collectively pulls the motherboard 21, the tray 22 and the bottom wall 132 of the bottom shell 13 by the fastener 43 Namely, because the holding assembly 40 is hung on the hook 122, which prevents the top shell 12 and the bottom shell 13 from being protruded from the electrical device 1 toward outside (namely, from being curved).

According to the electrical device of the disclosure, the holding assembly located on the motherboard module is hung on the hook, and the hook provides the upward pulling force for motherboard module, which reduces the pressure of the motherboard module applying to the bottom wall and further restrains the deformation of the bottom wall. Furthermore, because the motherboard module is hung on the hook of the top shell, the top shell sustains part of the motherboard module's weight. Therefore, the electrical device in this embodiment of the disclosure solves the problem resulted from the uneven top shell and the uneven bottom shell in conventional electrical devices. The electrical device of the disclosure is, for example, a sever in a cabinet of a sever rack. The server with an uneven top shell or an uneven bottom shell would interfere with its adjacent servers in the cabinet of the sever rack, which affects the installation and disassembly of adjacent servers. In addition, in some other embodiment of the disclosure, the strip of the top shell can help to prevent the bending or curving from the top wall and further prevents the top shell from being protruded from the electrical device toward outside (namely, from being curved).

What is claimed is:

1. An electrical device, comprising:
a housing having a top shell and a bottom shell assembled with each other, wherein the top shell comprises a top wall and a hook fixed to the top wall, wherein the bottom shell has a bottom wall opposite to the top wall, and the hook is located on an area of the top wall which faces toward the bottom wall;
a motherboard module located on the bottom wall, wherein the motherboard module comprises a motherboard and a central processing unit located on the motherboard; and
a holding assembly securely located on the motherboard module and hung on the hook for providing an upward pulling force for the motherboard module.

2. The electrical device according to claim 1, wherein the motherboard module further comprises a tray for loading the motherboard which is located between the top wall and the tray.

3. The electrical device according to claim 2, wherein the holding assembly having a fixing portion and a hanging portion, the fixing portion extends from a bottom side of the hanging portion by bending from the bottom side of the hanging portion, wherein the fixing portion is fastened to the motherboard, and the hanging portion is hung on the hook.

4. The electrical device according to claim 3, wherein the holding assembly further comprises a fastener and the fixing portion further comprises a perforation, the fastener passes through the perforation and the motherboard to fasten with the tray.

5. The electrical device according to claim 4, wherein the fastener is a screw and the tray has a nut, and the screw is screwed to the nut.

6. The electrical device according to claim 3, further comprising a plurality of fans for dissipating thermal energy generated from the motherboard module, wherein the hanging portion faces toward the plurality of fans and has a plurality of vents, the airflow generated from the operation of the plurality of fans partially passes through the plurality of vents.

7. The electrical device according to claim 2, wherein the motherboard is securely locked on the tray, and the motherboard and the tray are integrally mounted to the bottom wall of the bottom shell.

8. The electrical device according to claim 1, wherein the top shell further comprises two edgefolds, the two edgefolds extend from the top wall toward the bottom wall and are formed by bending from the two opposite sides of the top wall respectively, wherein the bottom shell further comprises two side walls located on two opposite sides of the bottom wall, the two side walls extend from the bottom wall toward the top wall and are formed by bending from the two opposite sides of the bottom wall respectively, wherein the top shell is assembled on top sides of the two side walls of the bottom shell and the two edgefolds directly abut against the two side walls, respectively, wherein the top shell further comprises a strengthen strip extending from a side edge of the top wall and for strengthening the top wall's ability against deformation, and the strip is located between the two edgefolds of the top shell and formed by bending from the side edge of the top wall.

9. The electrical device according to claim 1, wherein the hook includes a connecting section, an extended section and a hook section, the connecting section is riveted on the top shell, the extended section extends toward the bottom wall from the connecting section, the hook section extends from the extended section and the holding assembly is hung on the hook section.

10. The electrical device according to claim 9, wherein the top shell is assembled to the bottom shell along a front to back direction; the hook section extends from the extended section along the front to back direction; with the top shell assembled to the bottom shell along the front to back direction, the holding assembly is hung on the hook section along a back to front direction.

11. The electrical device according to claim 9, wherein a guiding surface which is inclined is formed from a free end of the hook section for guiding the holding assembly to be hung on the hook.
